(19) United States
(12) Patent Application Publication
(10) Pub. No.: US 2006/0164941 A1
(43) Pub. Date: Jul. 27, 2006

(54) Recording medium reproduction device and computer program for reproducing recording medium

(76) Inventors: Hiroyuki Fukuma, Osaka (JP); Fumiaki Kawamura, Osaka (JP)

Correspondence Address: PILLSBURY WINTHROP SHAW PITTMAN LLP, 1650 TYSONS BOULEVARD, MCLEAN, VA, 22102, US

(21) Appl. No.: 10/548,531

(22) PCT Filed: Mar. 22, 2004
(86) PCT No.: PCT/JP04/03877

§ 371 Date: Sep. 12, 2005

(30) Foreign Application Priority Data
Apr. 16, 2003 (JP) 2003-111204

(51) Int. Cl. G11B 5/09

(52) U.S. Cl. 369/53.2; 369/47.1

(57) ABSTRACT

The present invention relates to a recording medium player which reads title set data and control information from a DVD and plays images and sounds. A multi-disc changer as a recording medium player includes a title selector (30) and a player section (200). If the control information read from a DVD contains a command to display a menu before playing images or sounds of a title piece which constitutes a main content, the title selector selects a title piece, which is selectable from the menu and has a playback time not shorter than a predetermined time, as a main title piece. The player section reads the title set data corresponding to the main title piece from the DVD and plays images and sounds.

### TECHNICAL FIELD

The present invention relates to recording medium players for e.g. DVDs (Digital Versatile Discs) which read title set data and control information from the medium and play content in the medium. The present invention also relates to computer programs for causing computers having the player function to execute predetermined procedures.

### BACKGROUND ART

Disc players can be categorized into two types: single disc players and multi-disc changers. Single disc players can be loaded with only one disc, and play that disc. Multi-disc changers can be loaded with a plurality of discs, and play these discs continuously. In multi-disc changers, the user can specify the order of playing the discs in the player, and each time a disc is finished, the player automatically plays the next disc.

Unlike single disc players, multi-disc changers do not require the user to manually exchange discs every time a disc is finished. Therefore, multi-disc changers are convenient when continuously playing a plurality of music pieces, movies and so on, or when playing a single piece of long movie for example which is recorded in a plurality of discs.

There is a problem, however. For instance, in DVD discs which contain movies, it is common that the disc contains, in addition to the main content of the movie itself (images and sounds), extra content such as bonus items (e.g. retakes not included in the movie itself), advertisements, etc. The disc usually displays a menu first, listing all these different pieces of content for selection to play. With this, every time the multi-disc changer starts the next disc in the order, the first thing that happens is the menu displayed on the screen, and continuous play is virtually impossible.

Assume that a movie is divided in two discs: DVD disc A and DVD disc B, and each DVD disc contains, in addition to the movie itself, extra pieces such as bonus items and advertisements. After DVD disc A (movie main content, first half) is over, the player automatically changes the discs and begin playing DVD disc B. However, the DVD disc B will display a menu first, and until the user selects the movie (main content, last half), the menu will stay forever, and the player which is in a waiting mode cannot play the last half contained in DVD disc B continuously to the first half contained in DVD disc A.

There is another problem. There are DVDs which are programmed to display the menu automatically every time a piece of content is over so that the user can select the next piece or stop playing. Assume two DVDs A and B of this type are loaded on a multi-disc changer, and a single piece of movie is contained in fractions in the two discs A and B. Now, the first half of the movie in DVD disc A is over, but until the user selects STOP PLAY in the menu, the player will not begin playing DVD disc B. In this case again, it is impossible to play the last half contained in DVD disc B continuously to the first half contained in DVD disc A.

The applicant has already proposed a solution (JP-A 2001-351312) to the problems encountered when continuous reproduction is wished for a plurality of DVDs which are programmed to display a menu after finishing a piece of content. In this solution, when a menu is displayed after the main content (main title piece) is over, the multi-disc changer determines that the main content is over and automatically changes the discs without posing for the menu if the playback time has exceeded a predetermined norm time.

This solution has enabled automatic change to DVD disc B after the first half recorded in DVD disc A has been over. However, if DVD disc B is programmed to display a menu first, it is impossible to continuously play the last half contained in DVD disc B unless the user selects the last half in the menu.

Therefore, the invention disclosed in JP-A 2001-351312 cannot solve the problem described above, i.e. a problem for continuously playing DVDs which are programmed to display a menu first and assume a waiting mode until a selection is made before content is played.

This can also be a problem in single disc players when playing a DVD which displays a menu first and assumes a waiting mode until the user makes a selection. Specifically, when the user wants to play the main content right after loading the disc, the single disc player will first play the menu and will not start playing the main content until the user has selected the main content in the menu. In another occasion, the user may want to watch the movie recorded in the DVD repeatedly on a single disc player. In this case again, the user is forced to repeat the same selection of the main content every time the movie is over and the menu comes up.

JP-A 2002-74908 discloses a DVD auto-changer which will not display a menu after discs are changed and begin playing the main content unconditionally, thereby preventing unwanted halt on the play. However, this method ignores the intent of the disc producer that the menu should be displayed (navigation violation). Essentially, such a DVD auto-changer which will ignore the DVD producer's will and not display the menu is not permitted.

### DISCLOSURE OF THE INVENTION

It is therefore an object of the present invention to provide a recording medium player capable of solving or reducing the above-mentioned conventional problems, and a computer program for making a computer function as such a recording medium player.

A first aspect of the present invention provides a recording medium player for recording medium containing: title set data which is a set of contents edited by title pieces; and control information which includes a playback time for each title piece, a playback procedure, and a menu for allowing a user to choose a desired title piece. The recording medium player reads the title set data and the control information from the recording medium and plays the contents included in the title set data based on the control information. The recording medium player includes: a title piece selector which selects a title piece having a playback time not shorter than a predetermined time as a main title piece from a plurality of selection buttons displayed in the menu upon display of the menu before playback of a main content based on the control information read from the recording medium; and a player which reads the title set data corresponding to the title piece selected by the title piece selector as the main title piece and plays the content included in the title set data.

Preferably, the title piece selector includes: a command checker which checks each selection button for a related command; a playback time checker which, upon finding by the command checker of a command for playing a title piece, checks a playback time of the title piece represented by the button; and a determiner which checks if the playback time found by the playback time checker is not shorter than the predetermined time.

Preferably, the recording medium contains a plurality of the menus, and upon failure in selecting the main title piece from one of the menus, the title piece selector moves on to another of the menus for selection of the main title piece.

Preferably, the recording medium player further includes a second title piece selector which, upon failure by the first title piece selector in selecting the main title piece from the menu, selects a title piece whose playback time is shorter than the predetermined time for a plurality of times from the menu. The player then reads title set data corresponding to the title piece selected by the title piece selector and plays content included in the title set data for each selection of a title piece selected by the second title piece selector until the predetermined time is passed.

Preferably the recording medium player further includes: an exchanger/holder for exchangeably holding a plurality of pieces of the recording medium; and a playback controller for changing a piece of the recording medium with another upon completion of a playback operation of the main title piece by the title piece selector and the player. The playback controller then causes the new piece of the recording medium to have its main title piece played by the title piece selector and the player.

Preferably, the recording medium player further includes a playback controller which, upon completion of a playback operation of a main title piece by the title piece selector and the player, causes the title piece selector and the player to play the main title piece in the same in recording medium again.

A second aspect of the present invention provides a recording medium player for recording medium containing: title set data which is a set of contents edited by title pieces; and control information which includes a playback procedure for each title piece and a menu for allowing a user to choose a desired title piece. The recording medium player reads the title set data and the control information from the recording medium and plays the content included in the title set data based on the control information. The recording medium player includes: a signal generator which, upon display of the menu before playback of a main content based on the control information read from the recording medium, generates a signal for confirming a selection made from a plurality of buttons in the menu; and a player which, upon confirmation by the signal of the selection of a button, reads the title set data corresponding to the title piece selected by the button and plays the content included in the title set data.

Preferably, the signal generator generates the signal in a predetermined time since the menu is displayed.

Preferably, the signal generator, upon display of the menu after completion of a playback of content of a title piece by the player, generates a signal for confirming a selection made on the menu until a predetermined time has passed since reading of the recording medium is started.

The recording medium may contain a plurality of the menus, and the signal generator generates the signal every time the menu is displayed until a predetermined time has passed since reading of the recording medium is started.

Preferably, the recording medium further includes: an exchanger/holder for exchangeably holding a plurality of pieces of the recording medium; and a playback controller for changing a piece of the recording medium with another upon completion of a playback operation of the title piece by the signal generator and the player. The playback controller then causes the new piece of medium to have its title piece played by the signal generator and the player.

Preferably, the recording medium further includes a playback controller which, upon completion of a playback operation of a title piece by the signal generator and the player, causes the signal generator and the player to play the title piece in the same in recording medium again.

A third aspect of the present invention provides a computer program for recording medium for causing a computer to function as a player for recording medium containing: title set data which is a set of contents edited by title pieces; and control information which includes a playback time for each title piece, a playback procedure, and a menu for allowing a user to choose a desired title piece. The player reads the title set data and the control information from the recording medium and plays the content included in the title set data based on the control information. The program causes the computer to function as: a title piece selector which selects a title piece having a playback time not shorter than a predetermined time as a main title piece from a plurality of selection buttons displayed in the menu upon display of the menu before playback of a main content based on the control information read from the recording medium; and a player which reads the title set data corresponding to the title piece selected by the title piece selector as the main title piece and plays the content included in the title set data.

A fourth aspect of the present invention provides a computer program for recording medium for causing a computer to function as a recording medium player for recording medium containing: title set data which is a set of contents edited by title pieces; and control information which includes a playback procedure for each title piece and a menu for allowing a user to choose a desired title piece. The player reads the title set data and the control information from the recording medium and plays the content included in the title set data based on the control information. The program causes the computer to function as: a signal generator which, upon display of the menu before playback of a main content based on the control information read from the recording medium, generates a signal for confirming a selection made from a plurality of buttons in the menu; and a player which, upon confirmation by the signal of the selection of a button, reads the title set data corresponding to the title piece selected by the button and plays the content included in the title set data.

According to the present invention, even if the recording medium is designed to display a menu after loading and before playing a main content, reproduction does not stop where the menu is displayed, and the user can immediately enjoy the main content without any need for selecting reproduction of the main content.

Other characteristics and advantages of the present invention will become clearer from the following description of the mode of embodiment of the present invention.

### BRIEF DESCRIPTION OF THE DRAWINGS

FIG. 1 is a system configuration diagram of a recording medium player according to a first embodiment of the present invention.

FIG. 2 is a format chart of a DVD disc.

FIG. 3 is a function block diagram of a multi-disc changer.

FIG. 4 is a flowchart of a procedure in a continuous play mode.

FIG. 5 shows a display example of a menu.

FIG. 6 shows a display example of a menu.

FIG. 7 is a function block diagram of a multi-disc changer according to a second embodiment.

FIG. 8 is a flowchart of a procedure in a continuous play mode of the multi-disc changer according to the second embodiment.

FIG. 9 is a flowchart of a procedure in a simple play mode of a single disc player according to a third embodiment.

### BEST MODE FOR CARRYING OUT THE INVENTION

Hereinafter, preferred modes of embodiment of the present invention will be described with reference to the drawings.

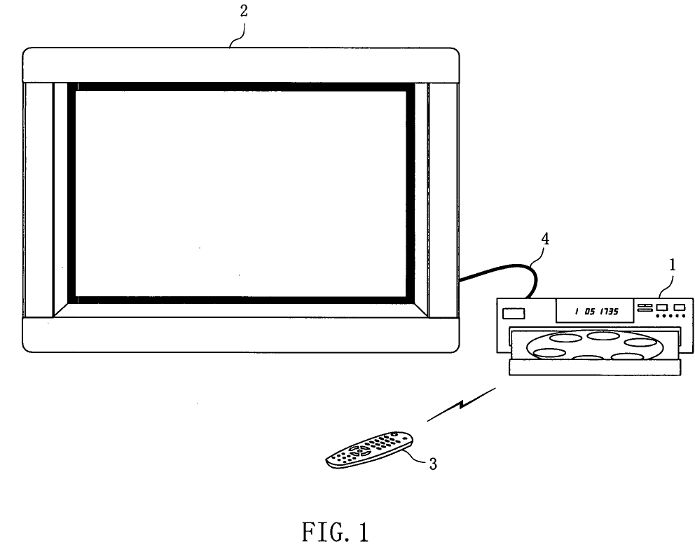

FIG. 1 is a system configuration diagram of a recording medium player according to a first embodiment of the present invention. The recording medium player includes a multi-disc changer 1 capable of holding a plurality of discs and playing them while automatically changing the discs. The multi-disc changer 1 is connected with a television set 2 which is capable of outputting images and sounds, via a cable 4. The multi-disc changer 1 comes with a remote controller 3 for inputting various operational commands. The user can input various operational commands of the multi-disc changer 1 from the remote controller 3 as well as from a control panel on the main body.

The term “playback” as used in the present embodiment refers to a series of operations of the multi-disc changer 1 until image (video) signals and sound (audio) signals are sent to the television set 2 based on digital signals read out of the disc. Although the multi-disc changer 1 is not a DVD-dedicated apparatus, and is also capable of playing video CDs and CD-DAs, description will be made only for a case of playing DVDs in the present embodiment.

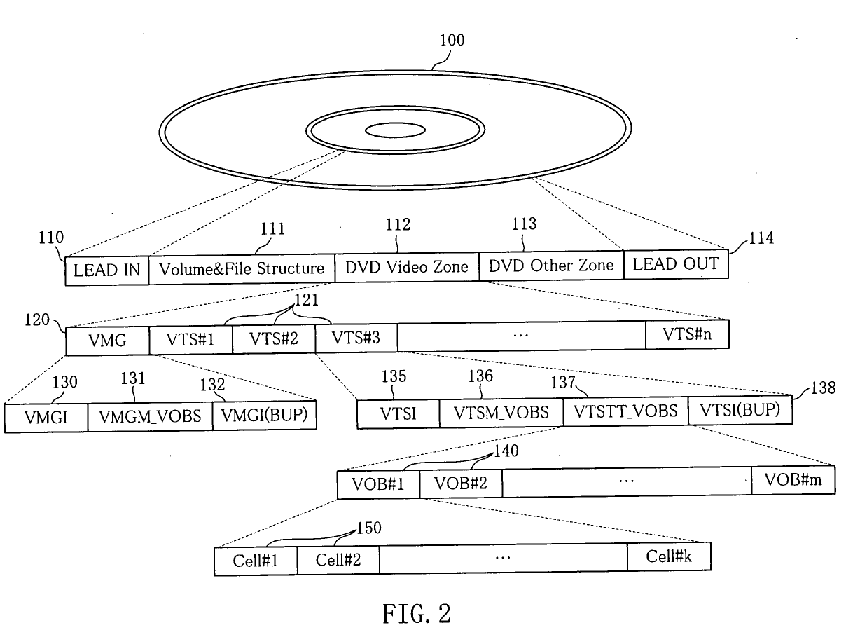

FIG. 2 is a format chart of a DVD. A DVD 100 has a recording area including Lead-in Area 110, Volume & File Structure 111, DVD Video Zone 112, DVD Other Zone 113, and Lead-out Area 114.

Lead-in Area 110 records a starting address of data which should be read out first. Volume & File Structure 111 records information regarding UDF (Universal Disk Format). DVD Video Zone 112 records a VMG (Video Manager) 120 and a plurality of VTSs (Video Title Sets) 121 . . . . DVD Other Zone 113 records other data than in DVD Video Zone 112. Lead-out Area 114 records information indicating the end of access to the DVD 100.

VMG 120 includes VMGI (Video Manager Information) 130, VMGM-VOBS (Video Object Set for VMG Menu) 131 and a backup VMGI(BUP) 132. VTS 121 includes VTSI (Video Title Set Information) 135, VTSM_VOBS (Video Object Set for the VTS Menu) 136, VTSTT_VOBS (Video Object Set for Titles in a VTS) 137 and a backup VTSI (BUP) 138.

VMGI 130 contains control information for the entire DVD video zone 112. An example of the information contained in VMGI 130 is information about the DVD 100 and procedures for playing a menu of the entire DVD 100. VMGI 130 also contains commands for example, to be executed when beginning to read data from the DVD 100. VMGI (BUP) 132 is an exact copy of the VMGI 130.

VMGM_VOBS 131 contains image data and sound data of the menu for the entire DVD 100 as well as other information such as control information for buttons in the menu.

VTSI 135, which is contained in a VTS 121, contains control information for playing a title piece in this particular VTS 121. The information contained in VTSI 135 includes procedures for playing Cells 150 . . . which will be described later, and information about playback time for each of the Cells 150 . . . . VTSI 135 also contains pre-commands to be executed before playing the Cells 150, as well as post-commands to be executed after playing the last Cell 150. VTSI 135 contains information about the title pieces which are contained together with this VTSI 135 in the VTS 121, as well as information about the menu for selecting the title pieces. VTSI (BUP) 138 is an exact copy of VTSI 135.

VTSM-VOBS 136 contains image data and sound data of a menu for making selections of a title pieces contained in VTS 121, as well as other information such as control information for button in the menu.

VTSTT_VOBS 137 contains image and sound data as well as subtitle data of a title piece. A title piece includes one or more Cells 150, and VTSI 135 describes procedures for playing these Cells 150. A plurality of Cells 150 . . . make up a VOB file 140.

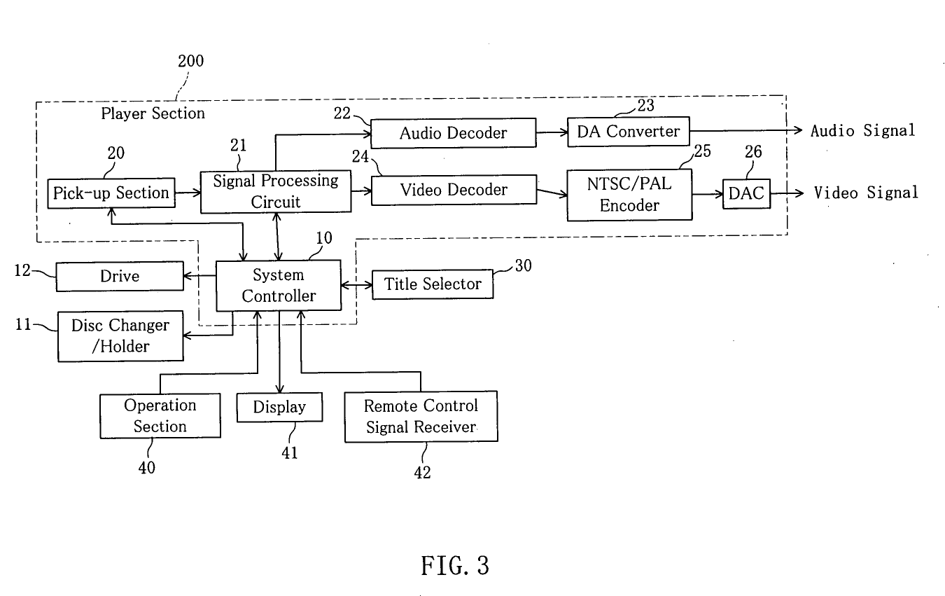

FIG. 3 is a function block diagram of the multi-disc changer 1. The multi-disc changer 1 includes a system controller 10, a disc changer/holder 11, a drive 12, a pick-up section 20, a signal processing circuit 21, an audio decoder 22, a DA converter 23 for the audio decoder, a video decoder 24, an NTSC/PAL encoder 25, a DA converter 26 for the NTSC/PAL encoder, a title selector 30, an operation section 40, a display 41 and a remote control signal receiver 42.

The system controller 10 is connected with the disc changer/holder 11, the drive 12, the pick-up section 20, the signal processing circuit 21, the title selector 30, the operation section 40, the display 41 and the remote control signal receiver 42. The pick-up section 20 has an output end, which is connected with an input end of the signal processing circuit 21. The signal processing circuit 21 leads to an audio output line for sending audio signals to the television set 2 (not illustrated) via the audio decoder 22 and the DA converter 23, and to a video output line for sending video signals to the television set 2 via the video decoder 24, NTSC/PAL encoder 25 and the DA converter 26. It should be noted here that the title selector 30, which is a function of the system controller 10, is illustrated separately from the system controller 10 because it constitutes an essential part of the present invention.

The system controller 10 is provided by a micro computer, and controls operations of the entire multi-disc changer 1. The micro computer includes a CPU, a ROM, a RAM, etc. The ROM stores programs for causing the CPU to execute predetermined procedures.

The disc changer/holder 11 includes a turntable which can accommodate a plurality of DVDs 100 . . . , a motor for turning the turntable, etc. The disc changer/holder 11 changes a DVD 100 on the pick-up section 20 with another, in response to a command from the system controller 10.

The drive 12 includes a spindle motor for turning discs, a drive circuit therefore, etc., and rotates a DVD 100 on the pick-up section 20 in response to a command from the system controller 10.

The pick-up section 20, which includes optical members, servo system, etc. for reading signals from the DVD 100, outputs the signals from the DVD 100 to the signal processing circuit 21 in response to a command from the system controller 10.

The signal processing circuit 21 demodulates the signals from the DVD 100, corrects errors, then splits the signals into audio data and video data, and outputs these signals to designated targets. The signal processing circuit 21 also sends control information (VMGI 130 or VTSI 135) read out from the DVD 100 to the system controller 10.

The audio decoder 22 decodes the audio data sent from the signal processing circuit 21. Decoded audio data is then converted into analog audio signals by the DA converter 23, and outputted to the television set 2, and thus, the television set 2 outputs sound from its speaker system.

The video decoder 24 decodes video data sent from the signal processing circuit 21. Decoded video data is then encoded by the NTSC/PAL encoder 25 into data of NTSC or PAL format, and then converted into analog video signals by the DA converter 26 before outputted to the television set 2. The television set 2 thus outputs images on its screen.

The above-described system controller 10, pick-up section 20, signal processing circuit 21, audio decoder 22, DA converter 23, video decoder 24, NTSC/PAL encoder 25 and DA converter 26 constitute a player section 200 which reads out audio data and video data from the DVD 100 and put them into the original audio and video signals.

The title selector 30 works as follows if a continuous playback mode is selected by the user: Specifically, when control information is sent from the signal processing circuit 21 to the system controller 10, the title selector analyzes the control information. More specifically, the selector searches buttons in a menu which is to be displayed on the basis of the control information, for one representing a title piece (hereinafter called “main title piece” whose playback time is equal to or longer than thirty minutes or an hour for example. Upon finding such a button, the selector then finds and automatically executes a related button command. In normal DVDs 100, this arrangement leads to automatic playback of a main title piece, i.e. the main content, even if the menu is displayed before the playback of the main content.

The operation section 40 includes, for example, operation keys such as a START PLAY/STOP PLAY key, keys for various selections and other keys (including an “Enter” key for input confirmation). The section inputs signals to the system controller 10 in response to each key operation. The operation section 40 also includes a continuous playback mode key for the user to select a continuous playback mode in which playback is made continuously while sequentially changing a plurality of DVDs 100. With the continuous playback mode key turned ON, the system controller 10 provides control in accordance with the continuous playback mode.

The display 41 indicates playback status of the DVD 100 and is controlled by the system controller 10.

The remote control signal receiver 42 is a wireless receiver of control signals from the remote controller 3. Although no specific depiction is given in the drawings, the remote controller 3 is also provided with various keys including the continuous playback mode key. When the remote control signal receiver 42 receives key operation signals from remote controller 3, the key operation signals are sent to the system controller 10.

Next, description will be made for an operation of the multi-disc changer 1.

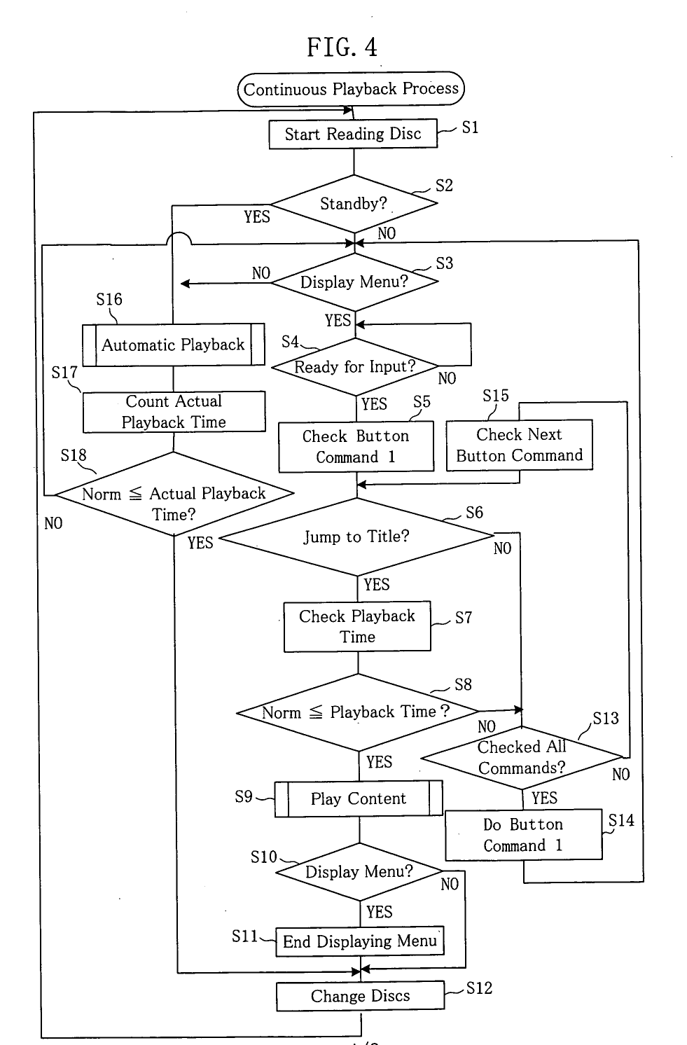

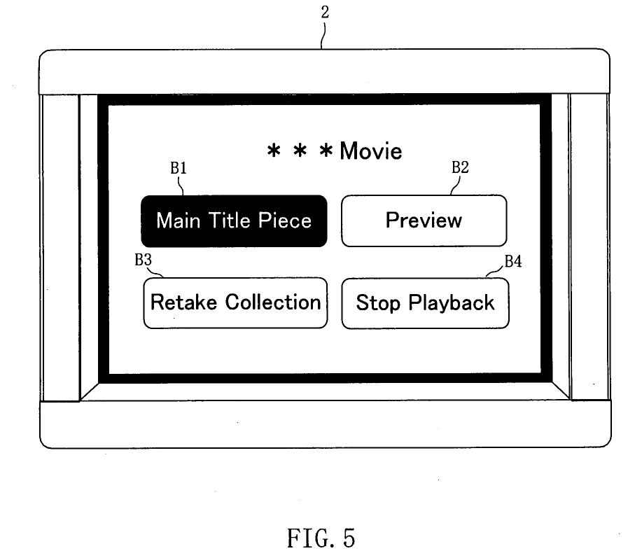

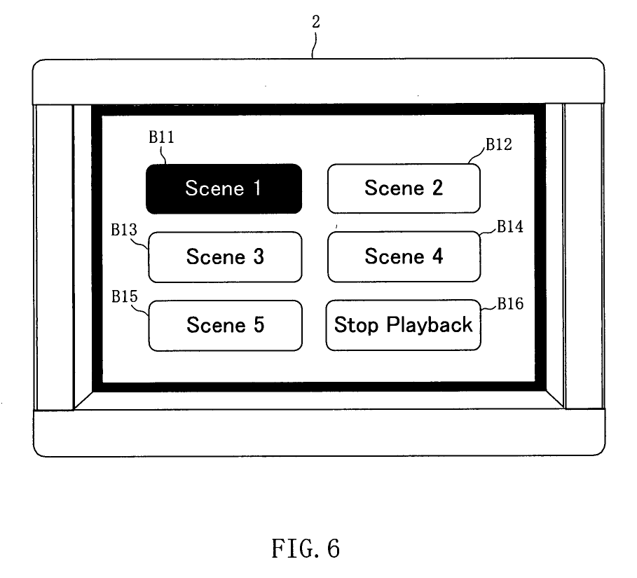

FIG. 4 is a flowchart of a processing procedure in the continuous playback mode. FIG. 5 and FIG. 6 are examples, showing how menus are displayed. When the user puts a plurality of DVDs 100 . . . in the disc changer/holder 11, selects the continuous playback mode and starts playback, the pick-up section 20 begins to read signals from one of these DVDs 100 (step S1). The first signals to be read are from VMGI 130. VMGI 130 is then sent to the system controller 10 via the signal processing circuit 21. Such an operation is commonly called “loading”.

Based on the information in VMGI 130, the system controller 10 determines whether to play a title piece, or display a menu, or to go to a stop state without doing either (step S2, step S3).

If a menu is to be displayed first, (step S2: NO, step S3: YES), the system controller 10 reads VMGM-VOBS 131 or VTSM-VOBS 136, i.e. image data and sound data which are related to the menu, from the DVD 100 through the pick-up section 20 and the signal processing circuit 21.

When signals based on the menu image data and sound data are outputted to the television set 2, the menu is displayed on the screen of the television set 2 as shown in FIG. 5. Once the menu appears, with buttons displayed therein, input operation by selecting a button in the menu, for example, becomes possible (step S4: YES), and the system controller 10 makes further reference to information about the menu buttons to see a button command represented by the first selection button (step S5).

The “first selection button” as used herein refers to a button which is selectable firstly in the menu. For example, the menu in FIG. 5 lists different choices, i.e. Button B1 for choosing the “main content”, Button B2 for choosing “preview”, Button B3 for choosing “retakes” and Button B4 for choosing “stop playback”. Among these, the highlighted button, which is Button B1 for choosing the “main content” is regarded as the “first selection button”.

If the first selection button represents a jump command for playing a title piece (step S6: YES), the system controller 10 makes reference to VTSI 135 and a VMGI 130 which contains the title piece, to check a playback time for the title piece linked to the jump command (step S7).

If the playback time of the title piece linked to the jump command is not shorter than a predetermined time (step S8: YES), the system controller 10 reads the title piece as a main title piece from the DVD 100, and plays the main title piece through the signal processing circuit 21, etc. (step S9). Note that the predetermined time is a length of time on the order of thirty minutes or an hour for example. For this reason, if the DVD 100 is a movie disc, a main title piece will be a title piece which is the main content or the movie itself.

When the title piece which has been related to the main title piece is played, the signal processing circuit 21 processes VTSTT_VOBS 137, based on VTSI 135 in the VTS121 that contains this particular title piece, thus outputting audio signals and video-signals to the television set 2. In other words, the speaker system of the television set 2 outputs sounds from the main title piece, and at the same time, the screen of the television set 2 displays images from the main title piece.

When the playback of the main title piece is over, the system controller 10 makes reference to post commands contained in VTSI 135 and determines whether to display the menu or not (step If the menu is to be displayed (step S10: YES), the system controller 10 reads the VMGM_VOBS 131 or VTSM_VOBS 136 again, from the DVD 100, displays the menu momentarily, and then terminates the display right away (step S11).

Thereafter, the system controller 10 stops rotation of the DVD 100 and has the disc changer/holder 11 change DVDs 100 (step S12). Thereafter, the process goes back to step S1, and the system controller 10 performs the same sequence of processes to the new DVD 100.

If the system assumes a stop state without displaying the menu in step S10 (step S10: NO), the system controller 10 skips step S11 and goes to step S12.

In step S8, if the playback time of the title piece related to the jump command is shorter than the predetermined time (step S8: NO), and all button commands related to the selection buttons in the menu have been checked (step S13: YES), the system controller 10 executes a button command related to the first selection button (step S14), and then brings the process back to step S3. In such a case, data is read from the DVD 100, based on the button command which is related to the first selection button. Thus, the screen in the television set 2 will show a different menu from the one in FIG. 5, an example of which is shown in FIG. 6. Otherwise, the title piece is played.

In step S13, if not all of the button command are checked yet (step S13: NO), the system controller 10 checks the button command which is related to the selection button next to the first selection button (step S15), and then goes to step S6. This is because the DVD 100 main have its main title piece linked to the second or later a selection button.

In step S6, if the button command related to the first selection button is not the jump command to play the title piece, but something else such as for displaying a different menu (step S6: NO), the system controller 10 ignores the first selection button and checks a button command related to the next button in step S13.

In step S4, the system controller 10 will not go to the next step S5 until input operation has become possible (step S4: NO). Specifically, the menu is displayed tentatively, and then the continuous playback is continued.

In step S2 and step S3, if the stop state continues without displaying the menu first (step S2: YES), or if a title piece is to be played (step S3: NO), the system controller 10 reads out the first title piece to be played from the DVD 100, and begins automatic playback of the title piece through the signal processing circuit 21 etc (step S16).

There can be a case that after step S3 found YES, and the menu was displayed once or more, and then the process was brought to step S14, where the button command related to the first selection button is eventually selected. In this case, the title piece read out of the DVD 100 based on the button command may not have a playback time as long as the predetermined length, yet the system controller 10 will play the title piece automatically (step S16).

After step S16 and while playing the title piece, the system controller 10 counts the actual playback time which is the time from the beginning of the playback (step S17).

When the playback of the title piece is over, the controller checks if the actual playback time is longer than a predetermined time (S18). If the actual playback time at the time when the playback of the title piece is stopped is shorter than the predetermined time (i.e. the playback of the title piece has been stopped before the due time) (step S18: NO), the system controller 10 brings the process back to step S3 again.

On the other hand, If the actual playback time at the time when the playback of the title piece is stopped is longer than the predetermined time (step S18: YES), the system controller 10 goes to step S12, and changes the DVDs 100. Here again, the predetermined time is on the order of 30 minutes or one hour, for example. In other words, if the title piece is played immediately, without first displaying the menu, or even if the menu which was displayed first only contains title pieces whose playback times are shorter than the predetermined time, one or more than one title pieces are played until the actual playback time exceeds the predetermined time.

It should be noted here, that if the menu which was displayed first only contains title pieces whose playback times are shorter than the predetermined time (step S14), and if more than two title pieces are played until the actual playback time is exceeded (step S18: NO and then step S14), an arrangement may be made so that the title piece to be played at the second time is different from the title piece which is played at the first time, i.e. the program will choose the second selection button which is next to the first selection button.

Therefore, according to the multi-disc changer 1 offered by the first embodiment, even if the DVD 100 is so programmed as to display a menu before the main content of a movie is played, the continuous playback mode will not halt with the displayed menu, and without any interruption by the user, the system automatically moves from the menu display to playback of the main title piece which is the main content. Thus, it becomes possible to repeat continuous playback while automatically changing a plurality of DVDs 100.

According to JP-A 2003-74908, no description is made as for a way to find a main title piece if there is no main title piece in the first VST, and therefore, there is no guarantee that a main title piece is played. However, according to the present embodiment, the playback time of title pieces are checked to determine if the piece is a main title piece. Thus, it is always possible to play the main title piece automatically.

Further, in some DVDS, selecting the main content is impossible in one menu, but is in other menus. In this case, too, by repeating a procedure shown in the flowchart on FIG. 4, i.e. a cycle starting from step 3, through step S14 and then back to step S3, it is possible to find and play a main title piece i.e. as the main content, automatically.

Still in another case, a DVD 100 may only contain a plurality of relatively short title pieces (scenes). Again in this case, the system plays these title pieces automatically, checks the actual playback time upon completion of each playback, and then automatically changes DVDs if the actual playback time has exceeded a predetermined time. Therefore, it is possible to repeat continuous playback without any interruption by the user during the continuous playback mode.

Obviously, the program is able to handle DVDs 100 which allows playback of a main content without first displaying a menu. The program can automatically play a title piece regarding the main content, and then changes the DVD 100 with another when the actual playback time has exceeded a predetermined time.

Next, a second embodiment of the present invention will be described.

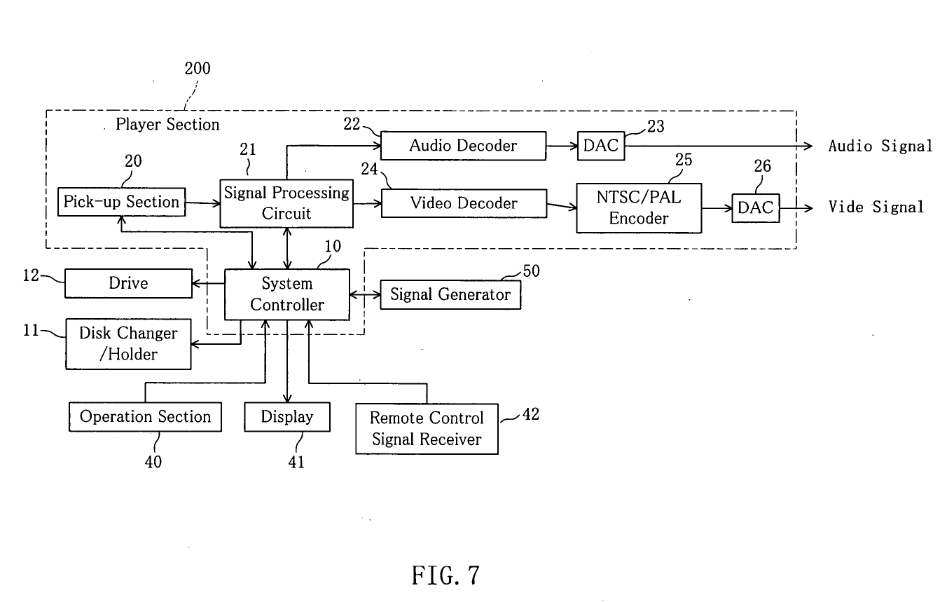

FIG. 7 is a function block diagram of a multi-disc changer according to the second embodiment. Since the multi-disc changer according to the second embodiment has generally the same constitution as the multi-disc changer 1 according to the first embodiment, the same reference codes will be used to indicate identical functional blocks and no description will be made for them.

The multi-disc changer according to the second embodiment includes a signal generator 50 which replaces the title selector 30 in the multi-disc changer 1 according to the second embodiment.

The signal generator 50 is separate from the system controller 10, automatically generates the same signal as generated when the ENTER key is depressed, and input the generated signal to the system controller 10. Specifically, when the user has chosen the continuous playback mode, and the system controller 10 notifies to the signal generator 50 that signals will be read from the DVD 100 and a menu will be displayed first, then the signal generator 50 automatically generates the ENTER signal in thirty seconds, for example, and inputs this signal to the system controller 10. Upon the lapse of thirty seconds since the menu is displayed, the system controller 10 becomes able to accept some input operations, and under such a circumstances, the controller which has received the ENTER signal from the signal generator 50 provides control accordingly.

For example, assume that a menu as shown in FIG. 5 is on display, and the first selection button in the menu (Button B1 for choosing “main content”) is highlighted. Then, the system controller 10 responds the ENTER input from the signal generator 50, by executing a button command related to the first selection button. Specifically, automatic playback of the main content will begin.

Next, an operation of the multi-disc changer according to the second embodiment will be described.

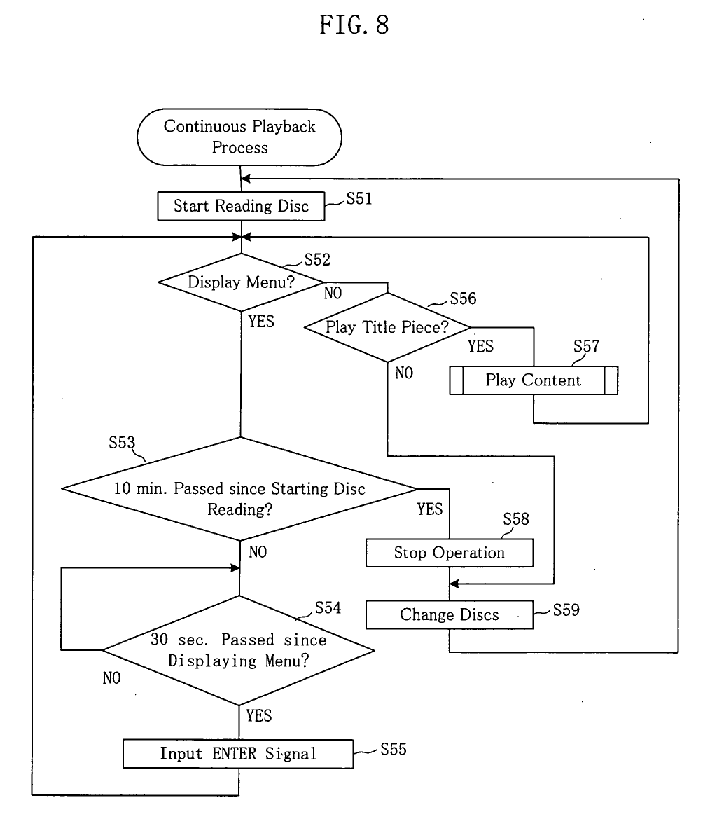

FIG. 8 is a flowchart showing a procedure in the continuous playback mode according to the second embodiment. When the user puts a plurality of DVDs 100 . . . in the disc changer/holder 11, selects the continuous playback mode and starts playback, the pick-up section 20 begins to read signals from one of these DVDs 100 (step S51). The first signals to be read are from VMGI 130. VMGI 130 is then sent to the system controller 10 via the signal processing circuit 21.

Based on the information in VMGI 130, the system controller 10 determines whether to display a menu or not (step S52) If a menu is to be displayed first, (step S52: YES), the system controller 10 reads VMGM_VOBS 131 or VTSM_VOBS 136, i.e. image data and sound data which are related to the menu, from the DVD 100 through the pick-up section 20 and the signal processing circuit 21.

While the menu is being displayed as described, the system controller 10 checks if ten minutes, for example, have passed since the beginning of signal reading (since the start of loading) from the DVD 100 (step S53).

If ten minutes have not passed yet, (step S53: NO), the system controller 10 then checks if thirty seconds have passed since the beginning of menu display (step S54).

If thirty seconds have passed since the beginning of menu display (step S54: YES), the signal generator 50 generates an ENTER signal, and inputs the signal to the system controller 10 (step S55). On the other hand, an ENTER signal is not accepted until thirty seconds have passed since the beginning of menu display (step S54: NO). In other words, the system controller 10 can accept an ENTER signal once thirty seconds have passed since the beginning of menu display, and will execute a button command which is related to the first selection button in the menu.

Normally, as shown in FIG. 5, the “first selection button” is a Button B1 for choosing “main content”. However, the “first selection button” may be a button for moving to another menu such as shown in FIG. 6. For this reason, the system controller 10 goes back again to step S52, and determines if the menu should be displayed further. Note that the “first selection button” is a button which appears on the screen as already highlighted.

If the “first selection button” is related to such a button command as “Display Menu” (step S52: YES), the system controller 10 goes back to the cycle of steps beginning with step S53. On the other hand, if a button command related to the “first selection button” is not a command saying “Display Menu” (step S52: NO) but a jump command i.e. a command saying “Play Title Piece” (step S56: YES), the system controller 10 reads the title piece from the DVD 100, and plays the title piece through the signal processing circuit 21, etc (step S57).

With this arrangement, if the DVD 100 is a normal movie DVD, a title piece which is the main content, i.e. the movie itself, is read out and played. Thus, the speaker system of the television set 2 outputs sounds from the main content, and at the same time, the screen of the television set 2 displays images from the main content. It should be noted here that if a menu is not first displayed (step S52: NO), and the program sees the “Play Title Piece” command right after the loading (step S56: YES), a title piece which is the main content is played according to the same procedure as described above.

On the other hand, after the title piece has been played, step S52 may find that the “first selection button” is related to a button command which says “Display Menu” (step S52: YES) Normally, this happens after ten minutes have been passed since the start of the loading (step S53: YES), and so the system controller 10 stops playback operations such as turning of the DVD 100 (step S58), and have the disc changer/holder 11 change DVDs 100 (step S59).

If the title piece is a short clip for example, the time from the loading to the end of playback may not be as long as ten minutes, and the menu may come up again, causing the program to repeat a cycle beginning with “step S53: NO”. In this case, there may be a couple of alternative arrangements when an ENTER signal is inputted in step S55. Specifically, a selection may be made for the first selection button, or the selection may be made for the second selection button rather than the first selection button. The first selection button will repeat playback of the same title piece whereas the second selection button will play another title piece automatically. In other words, it becomes possible to play a plurality of title pieces until a predetermined time is reached.

In step S52, if the “first selection button” is related to a button command saying “Display Menu” (step S52: YES), and a cycle of step S52-S55 has been repeated until ten minutes, for example, have passed since the start of the loading (step S53: YES), then again, the system controller 10 stops playback operations such as turning of the DVD 100 (step S58), and have the disc changer/holder 11 change DVDs 100 (step S59). Specifically, the DVD 100 will be changed with the next one if repeated input of the ENTER signal causes nothing but display of a menu. Once the DVD 100 is changed with another, system controller 10 goes back to step S51 and begins the above cycle to the new DVD 100.

In step S52, if the task is not to display a menu (step S52: NO), nor is it to play a title piece, and the system goes to a stop state (step S56: NO), then the system controller 10 bring the process to step S59. Specifically, when the system stops right after the loading, the program will change DVDs 100.

Therefore, according to the multi-disc changer offered by the second embodiment, display of a menu in the continuous playback mode before a main content is played will automatically generate an ENTER signal whereby selection of a first selection button is confirmed. Accordingly, playback is made for images and sound of a title piece regarding the main content, in most cases. Thus, it is possible to repeat continuous playback while automatically changing a plurality of DVDs 100.

Further, there is a case in which a menu is displayed after playing a main content (step S52: NO, step S56: YES, step S57 and then step S52: YES). Then, if step S53 finds that a predetermined time (e.g. ten minutes) have been passed since the start of the loading change DVDs 100, the next DVD 100 is loaded automatically, and so the system will not halt after playing the main content, with a menu displayed.

Next, a third embodiment of the present invention will be described.

A third embodiment relates to a single disc player. The single disc player has fundamentally the same configuration as in the functional block diagram given in FIG. 7, except that it does not include the disc changer/holder 11. Therefore, no additional description will be given as for the configuration.

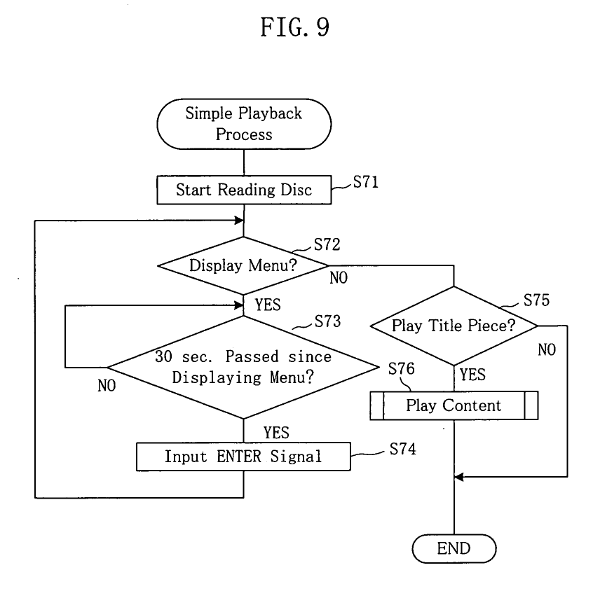

FIG. 9 is a flowchart of a process procedure in a simple play mode in the single disc player. The simple play mode as used herein is a mode in which, a main content of a movie recorded in a single DVD 100 is played only once, for example.

When a playback is started in the single disc player, pick-up section 20 begins to read signals from the DVD 100 (step S71). Here again, the first signals to be read are from VMGI 130, and VMGI 130 is then sent to the system controller 10 via the signal processing circuit 21.

Based on the information in VMGI 130, the system controller 10 determines whether to display a menu or not (step S72). If a menu is to be displayed first, (step S72: YES), the system controller 10 reads VMGM_VOBS 131 or VTSM_VOBS 136, i.e. image data and sound data which are related to the menu, from the DVD 100 through the pick-up section 20 and the signal processing circuit 21.

Once the menu is displayed as described, the system controller 10 checks if e.g. thirty seconds have passed since the beginning of menu display (step S73).

If thirty seconds have passed since the beginning of menu display (step S73: YES), the signal generator 50 generates an ENTER signal, and inputs the signal to the system controller 10 (step S74). On the other hand, an ENTER signal is not accepted until thirty seconds have passed since the beginning of menu display (step S73: NO). In other words, as is in the second embodiment described above, the system controller 10 can accept an ENTER signal once thirty seconds have passed since the beginning of menu display, and will execute a button command which is related to the first selection button in the menu. Thereafter, the system controller 10 brings the process back to step 72, and determines again whether to display a menu or not (step S72).

If the “first selection button” is related to a button command saying “Display Menu” (step S72: YES), the system controller 10 repeats a cycle again which starts with step S73. On the other hand, if the “first selection button” is related to a button command which is a jump command saying “Play Title Piece” (step S72: NO, step S75: YES), the title piece is played according to the same procedure as in FIG. 8.

If no menu is to be displayed first (step S72: NO), and the program sees a command saying “Play Title Piece” right after the loading (step S75: YES), the same procedure as described above will be performed to play a title piece regarding the main content. Once the playback of the title piece is over, the system controller 10 stops all operation of the system, bringing the playback process to an end.

If the task is not to display a menu (step S72: NO), nor is it to play a title piece, and the system goes to a stop state (step S75: NO), then the system controller 10 bring the process to an end.

Therefore, when a single disc player plays a main content of a movie contained in a DVD 100, even if a menu is displayed before the main content is played, automatic selection and playback is made for the main content, and the user does not have to do any specific operation on the menu. The program enables to free the user from doing extra operations.

The present invention is not limited to these embodiments so far described.

The embodiments using the multi-disc changer are particularly suitable for continuous playback of a plurality of DVDs 100 one after another by automatically changing the discs. However, the continuous playback may be made repeatedly to the same DVD 100, and such a continuous playback may be used in a single disc player of course. Such an operation can easily be achieved in the flowchart in FIG. 4, by jumping from step S11 back to step S1, while skipping step S12. Likewise, in the flowchart in FIG. 8, the process will be brought back to step S51 without performing step S59.

In a single disc player, a simple one-time playback can be made automatically in the procedure shown in FIG. 9, but this is not the only way. An alternative may be use of the flow chart in FIG. 4, provided that the playback process is brought to an end without performing step S12. This alternative process offers the same advantage of freeing the user from doing extra operations.

Further, in a single disc player, a program operation after selecting the first selection button, playing a first title piece, and then coming back to the menu display may be to automatically select a different button than the first selection button, i.e. to select a second selection button, to play another title piece. With this arrangement, it becomes possible for a single disc which contains a plurality of title pieces to have these title pieces continuously and automatically. To achieve this, use the procedure in e.g. FIG. 9, and after step S76, go back to step S72, and then choose the second button in step S74.

A single disc player should simply include a mechanism in place of the disc changer/holder 11, for holding a single DVD 100.

A recording medium player may be a personal computer equipped with a DVD disc drive, a video game machine incorporating a DVD disc drive, or a DVD player integrated with a monitor screen.

Although the embodiments only cover the cases for DVDs 100 which primarily contain images and sound such as movies, the present invention is also applicable to DVD audio discs which primarily contain sounds such as music.

Obviously, recording medium is not limited to DVDs, and may certainly include blue-ray discs for example.

As has been described, the recording medium player according to the present invention displays a menu, yet plays a main content automatically, without ignoring the intent of the disc producer (without navigation violation).

1. A recording medium player for recording medium containing: title set data which is a set of contents edited by title pieces; and control information which includes a playback time for each title piece, a playback procedure, and a menu for allowing a user to choose a desired title piece; the player reading the title set data and the control information from the recording medium and playing the content included in the title set data based on the control information, the recording medium player comprising:
a title piece selector which selects a title piece having a playback time not shorter than a predetermined time as a main title piece from a plurality of selection buttons displayed in the menu upon display of the menu before playback of a main content based on the control information read from the recording medium; and
a player which reads the title set data corresponding to the title piece selected by the title piece selector as the main title piece and plays the content included in the title set data.

2. The recording medium player according to claim 1, wherein the title piece selector includes: a command checker which checks each selection button for a related command; a playback time checker which, upon finding by the command checker of a command for playing a title piece, checks a playback time of the title piece represented by the button; and a determiner which checks if the playback time found by the playback time checker is not shorter than the predetermined time.

3. The recording medium player according to claim 1, wherein the recording medium contains a plurality of the menus, upon failure in selecting the main title piece from one of the menus, the title piece selector moving on to another of the menus for selection of the main title piece.

4. The recording medium player according to claim 1, further comprising a second title piece selector which, upon failure by the first title piece selector in selecting the main title piece from the menu, selects a title piece whose playback time is shorter than the predetermined time for a plurality of times from the menu, the player reading title set data corresponding to the title piece selected by the title piece selector and playing content included in the title set data for each selection of a title piece selected by the second title piece selector until the predetermined time is passed.

5. The recording medium player according to claim 1, further comprising: an exchanger/holder for exchangeably holding a plurality of pieces of the recording medium; and a playback controller for changing a piece of the recording medium with another upon completion of a playback operation, by the title piece selector and the player, of the main title piece for the piece of the recording medium held by the exchanger/holder, and causing said another piece of the recording medium to have its main title piece played by the title piece selector and the player.

6. The recording medium player according to claim 1, further comprising a playback controller which, upon completion of a playback operation of a main title piece by the title piece selector and the player, causes the title piece selector and the player to play the main title piece in the same in recording medium again.

7. A recording medium player for recording medium containing: title set data which is a set of contents edited by title pieces; and control information which includes a playback procedure for each title piece and a menu for allowing a user to choose a desired title piece; the player reading the title set data and the control information from the recording medium and playing the content included in the title set data based on the control information, the recording medium player comprising:
a signal generator which, upon display of the menu before playback of a main content based on the control information read from the recording medium, generates a signal for confirming a selection made from a plurality of buttons in the menu; and
a player which, upon confirmation by the signal of the selection of a button, reads the title set data corresponding to the title piece selected by the button and plays the content included in the title set data.

8. The recording medium player according to claim 7, wherein the signal generator generates the signal after a predetermined 5 time since the menu is displayed.

9. The recording medium player according to claim 7, wherein the signal generator, upon display of the menu after completion of a playback of content of a title piece by the player, generates a signal for confirming a selection made on the menu until a predetermined time has passed since reading of the recording medium is started.

10. The recording medium player according to claim 7, wherein the recording medium contains a plurality of the menus, the signal generator generating the signal every time the menu is displayed until a predetermined time has passed since reading of the recording medium is started.

11. The recording medium player according to claim 7, further comprising: an exchanger/holder for exchangeably holding a plurality of pieces of the recording medium; and a playback controller for changing a piece of the recording medium with another upon completion of a playback operation, by the signal generator and the player, of the title piece for the piece of the recording medium held by the exchanger/holder, and causing said another piece of the recording medium to have its title piece played by the signal generator and the player.

12. The recording medium player according to claim 7, further comprising a playback controller which, upon completion of a playback operation of a title piece by the signal generator and the player, causes the signal generator and the player to play the title piece in the same in recording medium again.

13. A computer program for recording medium for causing a computer to function as a player for recording medium containing: title set data which is a set of contents edited by title pieces; and control information which includes a playback time for each title piece, a playback procedure, and a menu for allowing a user to choose a desired title piece; the player reading the title set data and the control information from the recording medium and playing the content included in the title set data based on the control information, the program causing the computer to function as:
a title piece selector which selects a title piece having a playback time not shorter than a predetermined time as a main title piece from a plurality of selection buttons displayed in the menu upon display of the menu before playback of a main content based on the control information read from the recording medium; and
a player which reads the title set data corresponding to the title piece selected by the title piece selector as the main title piece and plays the content included in the title set data.

14. A computer program for recording medium for causing a computer to function as a recording medium player for recording medium containing: title set data which is a set of contents edited by title pieces; and control information which includes a playback procedure for each title piece and a menu for allowing a user to choose a desired title piece; the player reading the title set data and the control information from the recording medium and playing the content included in the title set data based on the control information,
the program causing the computer to function as:
a signal generator which, upon display of the menu before playback of a main content based on the control information read from the recording medium, generates a signal for confirming a selection made from a plurality of buttons in the menu; and
a player which, upon confirmation by the signal of the selection of a button, reads the title set data corresponding to the title piece selected by the button and plays the content included in the title set data.
